(19) United States
(12) Patent Application Publication
(10) Pub. No.: US 2020/0278050 A1
(43) Pub. Date: Sep. 3, 2020

(54) SADDLE PIPE SUPPORT

(71) Applicant: HYDRA-ZORB CO., Auburn Hills, MI (US)

(72) Inventors: Robert Dodge, Birmingham, MI (US); Mark Schwager, Washington Twp., MI (US)

(21) Appl. No.: 16/762,526

(22) PCT Filed: Nov. 9, 2018
(86) PCT No.: PCT/US2018/059932

§ 371 Date: May 8, 2020

Related U.S. Application Data
(60) Provisional application No. 62/583,764, filed on Nov. 9, 2017.

(51) Int. Cl. F16L 3/02; F16B 2/08; F16L 3/24; F16L 59/135; F16L 3/12

(52) U.S. Cl. CPC F16L 3/02; F16B 2/08; F16L 3/1226; F16L 59/135; F16L 3/1218; F16L 3/245

(57) ABSTRACT

A pipe support is coupled to an elongated channel for receiving and supporting a pipe. The channel includes a base and a pair of spaced apart sidewalls extending from the base to a bottom plate. A flange projects downwardly from each top plate towards the base and defines a slot therebetween. The pipe support includes a body portion extending axially between opposite ends and having an inner surface and an outer surface. The body portion includes a generally arcuate bottom floor and a pair of spaced apart sidewalls projecting generally upwardly from the bottom floor. A pair of axially spaced apart channel locks projects downwardly from the outer surface of the body portion adjacent each of the spaced apart sidewalls of the channel. A retainer strap selectively connects to and between the channel locks for coupling the pipe support to the channel.

### CROSS-REFERENCE TO RELATED APPLICATIONS

This application claims priority to and all the benefits of United States Provisional Application No. 62/583,764, filed on Nov. 9, 2017.

### BACKGROUND OF THE INVENTION

### 1. Field of the Invention

The present invention relates to a pipe support. More particularly, the invention relates to a saddle pipe support adapted for connection to a channel for receiving and supporting a pipe.

### 2. Description of Related Art

Conventional pipes are used to convey or transfer fluids in various commercial and industrial applications and buildings, such as water and sprinkler systems, refrigeration systems, and heating/cooling systems. The pipes are commonly encased in a cellular foam insulation tubing, which maintains the fluid within the pipes at a desired temperature. The pipe insulation tubing is commonly provided in predetermined lengths that are aligned end-to-end to cover an entire length of pipe.

In a typical application and installation, the insulated pipe, that is, the pipe encased by the insulation tubing, is disposed along a support structure, such as a ceiling of the building. The insulated pipe is commonly supported along the support structure by a plurality of spaced apart clevis hangers or straps. An elongated metal U-shaped channel is typically fixedly secured to the support structure or ceiling for supporting the clevis hangers. The clevis hanger typically includes an upper member mounted to the channel and a generally U-shaped lower member coupled to the upper member for supporting the insulated pipe spaced below the channel. The shape of the lower member complements that of the outer periphery of the insulated pipe, thereby allowing the clevis hanger to support and retain the insulated pipe along the channel. Examples of common clevis hangers for supporting insulated pipes are shown in U.S. Pat. Nos. 7,207,527 and 7,520,475.

It is also known to provide a saddle shaped pipe support adapted to be connected to the U-shaped channel and shaped complementary to the insulated pipe to support a longitudinal length of the insulated pipe. The saddle pipe support includes a body portion having a curved bottom and arcuate upwardly extending walls for receiving and supporting the insulated pipe. A pair of spaced apart members having inwardly extending hooks or barbs extend downwardly from the body portion for receiving the outer walls of the channel therebetween to secure the saddle pipe support to the channel. A saddle pipe support known in the prior art is shown in U.S. Pat. No. 8,074,943.

However, it remains desirable to provide a more secure and stable connection between the saddle pipe support and the channel for supporting the insulated pipe.

### SUMMARY OF THE INVENTION

A pipe support is provided for receiving and supporting a pipe. The pipe support comprises a body portion extending axially between opposite ends and having an inner surface and an outer surface. The body portion includes a generally arcuate bottom floor and a pair of spaced apart sidewalls projecting generally upwardly from the bottom floor. A pair of axially spaced apart channel locks project downwardly from the outer surface of the body portion and a retainer strap selectively connects to and between the channel locks for operatively coupling the pipe support to a support structure.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a perspective view of the saddle pipe support according to one embodiment of the invention for supporting an insulated pipe;

FIG. 2 is an end view of the saddle pipe support;

FIG. 3 is a side view of the saddle pipe support connected to a U-shaped channel for supporting an insulated pipe;

FIG. 4 is a bottom view of the saddle pipe support; and

FIG. 5 is a cross-section view taken along line 5-5 of FIG. 4.

### DETAILED DESCRIPTION OF THE EMBODIMENTS

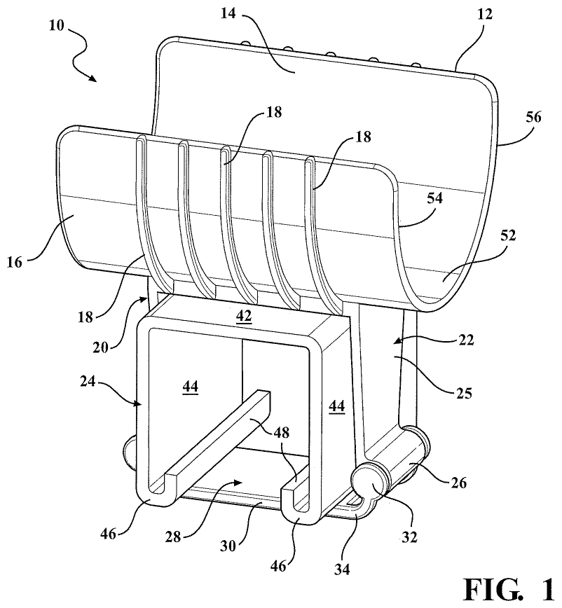

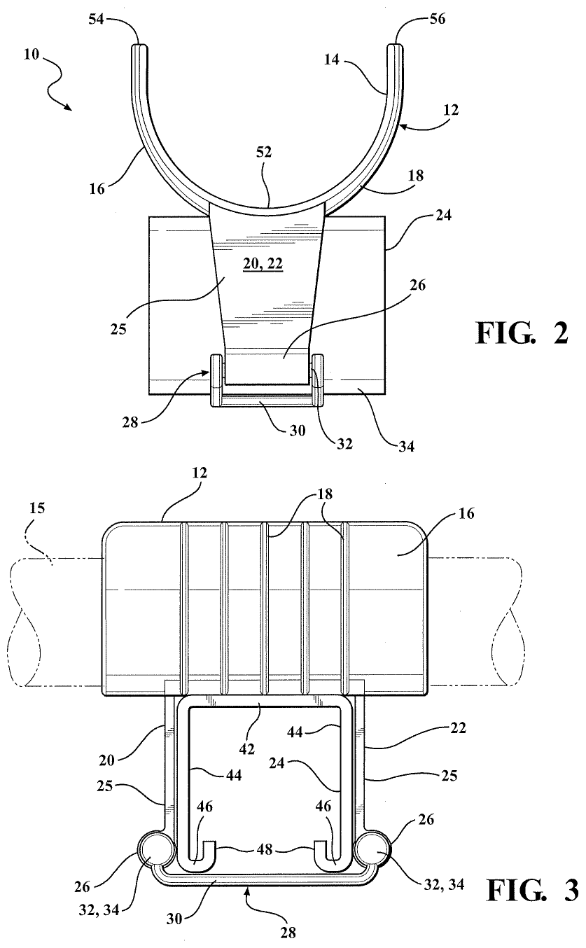

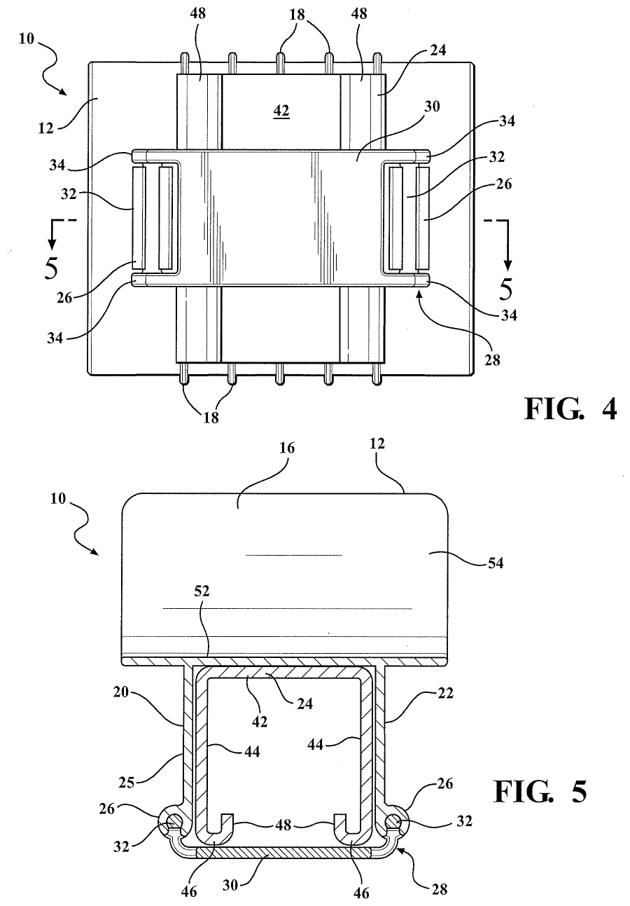

Referring to the Figures, wherein like numerals indicate like or corresponding parts throughout the several views, a saddle pipe support 10, preferably fabricated by molded plastic is shown in FIGS. 1-5, for supporting an elongated pipe 15. The pipe 15 is generally a fluid pipe used in commercial or industrial buildings for transferring fluid in water, refrigeration, or heating/cooling systems. Further, the pipe 15 is typically encased in a cellular foam insulation tubing for maintaining the temperature of the fluid in the pipe 15, collectively referred to herein as an insulated pipe 15.

The saddle pipe support 10 is adapted to be removeably coupled to a support structure commonly known as an elongated metal U-shaped channel 24 which is typically fixedly secured to a wall or ceiling of the building. The channel 24, which is commonly known in the art, includes a flat top base 42 extending between a pair of spaced apart upright sidewalls 44. A bottom plate 46 projects inwardly from each of the respective sidewalls 44 and is generally parallel to the top base 42. Each bottom plate 46 terminates with an upwardly turned flange 48 projecting toward but spaced from the top base 42. An elongated slot 50 is defined between the spaced apart and opposite facing flanges 48.

The pipe support 10 includes an elongated semi-cylindrical or generally U-shaped body portion 12 having an inner support surface 14 for supporting the insulated pipe 15 and an outer surface 16 reinforced by a plurality of transverse structural ribs 18. More specifically, the body portion 12 includes an arcuate bottom floor 52 and a pair of spaced apart upwardly or vertically extending sidewalls 54, 56. The body portion 12 extends axially, or longitudinally, between opposite ends and may terminate with downwardly curved or tapered lips projecting from the bottom floor 20. The structural ribs 18 are spaced apart transverse to the axial length of the body portion 12 and extend around the outer surface 16 of the bottom floor 20 and each sidewall 22, 24 to provide structural rigidity and strength to the pipe support 10.

A pair of spaced apart channel locks 20, 22 project downwardly from the outer surface 16 of the body portion 12 for connection to the elongated channel 24, as shown in FIG. 3. More specifically, each channel lock 20, 22 includes a vertical leg portion 25 extending downwardly from the body portion 12 to an elongated socket portion 26 projecting outwardly from the distal end of each leg portion 25 and between lateral socket ends to lockingly secure the saddle pipe support to the channel 24.

Finally, the saddle pipe support 10 further includes a retainer strap 28 for selectively engaging with and between the channel locks 20, 22 around the bottom plates 46 of the channel 24 to lockingly secure the saddle pipe support 10 to the channel 24. More specifically, the retainer strap 28 includes an elongated strap portion 30, a pair of spaced apart legs 34 extending outwardly and upwardly from each opposite end of the strap portion 30, and an elongated cylindrical rod 32 extending and supported between the spaced apart legs 34 and sized to be locking received and snapped into the respective elongated socket portions 26 of the channel lock 20, 22. The legs 34 projecting from each end of the strap portion 30 and supporting the rod 32 also provide a lateral abutment of the retainer strap 28 when coupled between the channel locks 20, 22.

In operation, the longitudinal axis of the saddle pipe support 10 is arranged transverse to the longitudinal axis of the channel 24 as shown in FIGS. 1 and 3. The leg portions 25 of the channel locks 20, 22 are positioned to straddle the opposite sidewalls 44 of the channel 24 with the outwardly extending sockets 26 adjacent the bottom plates 46 of the channel 24. The retainer strap 28 may be removably connected to the channel locks 20, 22 to retain the saddle pipe support 10 to the channel 24. That is, the rods 32 are sized to be snap fit into socket openings formed and defined by the respective elongated sockets 26 to lock the channel locks 20, 22, and thus the saddle pipe support 10, to the channel 24. The legs 34 define end walls to prevent the retainer strap 28 from sliding laterally out of the sockets 26.

As shown in FIG. 3, when the pipe support 10 is coupled to the channel 24, the sidewalls 44 of the channel 24 are seated in the space formed between the channel locks 20, 22. Once the saddle pipe support 10 is coupled to the channel 24, a length of insulated pipe 15 may be inserted between the sidewalls 54, 56 and supported by the bottom floor 52 of the body portion 12. It should be appreciated that the saddle pipe support 10 is configured to receive and support a pipe 15 whether encased in the insulation tubing or not.

If it desirable to disconnect the saddle pipe support 10 from the channel 24, the retainer strap 28 may be disconnected from the channel locks 20, 22 by simply removing one or both of the rods 32 from snap fit engagement with the respective sockets 26 and allowing the saddle pipe support 10 to be repositioned or removed from the channel 24.

The invention has been described in an illustrative manner, and it is to be understood that the terminology, which has been used, is intended to be in the nature of words of description rather than of limitation. Many modifications and variations of the present invention are possible in light of the above teachings. It is, therefore, to be understood that within the scope of the appended claims, the invention may be practiced other than as specifically described.

What is claimed is:

1. A pipe support adapted for receiving and supporting a pipe, said pipe support comprising:
a body portion extending axially between opposite ends and having an inner surface and an outer surface, said body portion including a generally arcuate bottom floor and a pair of spaced apart sidewalls projecting generally upwardly from said bottom floor;
a pair of axially spaced apart channel locks projecting downwardly from said outer surface of said body portion; and
a retainer strap selectively connected to and between said channel locks for operatively coupling said pipe support to a support structure.

2. The pipe support as set forth in claim 1 wherein said channel locks include a leg portion projecting from said outer surface of said body portion to a distal end.

3. The pipe support as set forth in claim 2 wherein said channel locks further include a socket portion projecting outwardly from said distal end of leg portion defining a socket opening.

4. The pipe support as set forth in claim 3 wherein said retainer strap includes an elongated strap portion extending between opposing ends, a pair of spaced apart legs projecting from each of said opposing ends of said strap portion, and an elongated cylindrical rod extending between said spaced apart legs wherein each of said rods are selectively engagable with said respective socket portions of said channel locks for operatively coupling said pipe support to the support structure.

5. The pipe support as set forth in claim 4 further including a plurality of axial spaced apart structural ribs formed on said outer surface of said body portion along said bottom floor and said sidewalls.

6. In combination, a pipe support adapted to be operatively coupled to an elongated channel for receiving and supporting a pipe, wherein
said channel includes a top base and a pair of spaced apart sidewalls extending from said top base to a bottom plate, wherein a flange projects upwardly from each bottom plate towards said top base and defines a slot therebetween; and
said pipe support includes a body portion extending axially between opposite ends and having an inner surface and an outer surface, said body portion including a generally arcuate bottom floor and a pair of spaced apart sidewalls projecting generally upwardly from said bottom floor; a pair of axially spaced apart channel locks projecting downwardly from said outer surface of said body portion adjacent each of said spaced apart sidewalls of said channel; and a retainer strap selectively connected to and between said channel locks for operatively coupling said pipe support to said channel.

6. The combination as set forth in claim 5 wherein said channel locks include a leg portion projecting from said outer surface of said body portion to a distal end adjacent said bottom plate of said channel.

7. The combination as set forth in claim 6 wherein said channel locks further include a socket portion projecting outwardly from said distal end of leg portion defining a socket opening.

8. The combination as set forth in claim 7 wherein said retainer strap includes an elongated strap portion extending between opposing ends, a pair of spaced apart legs projecting from each of said opposing ends of said strap portion, and an elongated cylindrical rod extending between said spaced apart legs wherein each of said rods are selectively engagable with said respective socket portions of said channel locks for operatively coupling said pipe support to said channel.

9. The combination as set forth in claim 8 wherein said retainer strap extends below said bottom plates of said channel between said spaced apart channel locks and said legs of said retainer strap abut said lateral ends of said socket portion to prevent lateral movement therebetween.

10. The combination as set forth in claim 9 wherein said pipe support further includes a plurality of axial spaced apart structural ribs formed on said outer surface of said body portion along said bottom floor and said sidewalls.
